(19) United States
(12) Patent Application Publication
(10) Pub. No.: US 2007/0230574 A1
(43) Pub. Date: Oct. 4, 2007

(54) Method and Device for Encoding Digital Video Data

(75) Inventor: Stephane Valente, Paris (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: Koninklijke Philips Electronics N.C.

(21) Appl. No.: 11/597,534

(22) PCT Filed: May 20, 2005
(86) PCT No.: PCT/IB05/51651

§ 371 Date: Nov. 22, 2006

(30) Foreign Application Priority Data
May 25, 2004 (EP) 04300302.9

(51) Int. Cl. H04N 11/02

(52) U.S. Cl. 375/240.13

(57) ABSTRACT

The invention relates to a method and device for encoding digital video data corresponding to an original sequence of images and available in the form of a video stream consisting of successive pictures which are either INTRA pictures or INTER pictures. The INTRA pictures are called I-pictures and encoded by means of a so-called INTRA mode without any reference to any past or future picture. The INTER pictures are either monodirectionally predicted pictures, called P-pictures and encoded with reference to a past or future reference picture which is an INTRA or INTER picture, or bidirectionally predicted pictures, called B-pictures and encoded with reference to one or more reference picture(s). The INTRA pictures themselves comprise either I-pictures placed at the beginning of a new group of pictures corresponding to a scene change, where no temporal redundancy is available, and called scene change I-pictures, or I-pictures placed in other locations, where some temporal redundancy is available, and called refresh pictures. According to the invention, the method is characterized in that, before being quantized and encoded in INTRA mode, said INTRA refresh pictures are replaced by an INTER picture having quality and artefacts substantially similar to those of the last encoded INTER picture(s).

### FIELD OF THE INVENTION

The present invention generally relates to the field of digital video compression and, for instance, to the video coding standards of the ISO/MPEG family (MPEG-1, MPEG-2, MPEG-4) and to the video recommendations of the ITU-H.26X family (H.261, H.263 and extensions, H.264).

More precisely, it relates to a method of encoding digital video data corresponding to an original sequence of images and available in the form of a video stream consisting of successive pictures which are either INTRA pictures, called I-pictures and encoded by means of a so-called INTRA mode without any reference to any past or future picture, or INTER pictures that are themselves either monodirectionally predicted pictures, called P-pictures and encoded with reference to a past or future reference picture which is an INTRA or INTER picture, or bidirectionally predicted pictures, called B-pictures and encoded with reference to one or more reference picture(s), said INTRA pictures themselves comprising either I-pictures placed at the beginning of a new group of pictures corresponding to a scene change, where no temporal redundancy is available, and called scene change I-pictures, or I-pictures placed in other locations, where some temporal redundancy is available, and called refresh pictures.

The invention also relates to a corresponding encoding device.

### BACKGROUND OF THE INVENTION

In modern digital video coding systems, two main modes are used to compress video signals: the INTRA mode and the INTER mode. In the INTRA mode, the luminance and chrominance channels are encoded by exploiting the spatial redundancy of the pixels in a given channel of a single image via transform coding. The INTER mode, exploiting the temporal redundancy between separate images, relies on a motion-compensation technique that predicts an image from one (or more) previously decoded image(s) by encoding the motion of pixels from one image to the other.

Usually, an image to be encoded is partitioned into independent blocks, each of them being assigned one or several motion vectors. A prediction of the image is constructed by displacing pixel blocks from the reference image(s) according to the set of motion vectors (luminance and chrominance channels share the same motion description). Finally, the difference, called the residual signal, between the image to be encoded and its motion-compensated prediction is encoded like in the INTRA mode by transform coding to further refine the decoded image.

In MPEG terminology, recalled for example in a document such as “MPEG video coding: a basic tutorial introduction”, by S. R. Ely, Report BBC RD 1996/3, the INTRA mode corresponds to I pictures or slices (a slice is a group of consecutive macroblocks), while the INTER mode corresponds to P and B pictures or slices. The coding efficiency of the INTER mode is much higher than the one of the INTRA mode, because it takes advantage of temporal prediction: much of the signal is contained in the prediction formed by motion compensation, and the residual signal has a smaller energy than the original signal. Because their encoding relies only on their own spatial redundancy, INTRA pictures can be decoded independently from any other pictures (which is not the case for INTER pictures). In spite of their lower coding efficiency, INTRA pictures are therefore inserted periodically in a bitstream to make random access points, begin new GOPs (Group of Pictures), or erase drifts between encoders/decoders (decoding errors due to channel losses or encoder/decoder implementation mismatches).

In the present patent application, the INTRA pictures that are placed at locations where an INTER picture would have been more efficient (in other words, the INTRA pictures at locations where a lot of temporal redundancy is available, not at scene changes) will be called “refresh” pictures. INTRA pictures can also be advantageously placed at scene-cuts, where no temporal redundancy will help the encoding. However, this invention specifically focuses on refresh INTRA pictures, not scene-cuts.

The problem overcome below by the invention is the following one: INTRA and INTER pictures exhibit different coding artefacts, since the underlying encoding method is different. Throughout an homogeneous video sequence, the quality and artefacts of subsequent INTER pictures tend to stabilize. However, if an INTRA refresh frame is encoded, all preceding artefacts, due to INTER coding, are erased, and new ones, due to INTRA coding, are introduced abruptly. Video quality is therefore disruptive at refresh frames, resulting in what is here called a flashing effect, especially visible in low motion sequences and at moderate or low bitrates (when coding artefacts become quite noticeable).

This flashing effect exists for all the MPEG family, but it is amplified by the latest standard, MPEG-4 part 10 (H.264), which uses a deblocking filter. In homogeneous and stable regions of INTER pictures, the deblocking filter has a very low impact, which results in almost unfiltered reconstruction, because little residual signal has to be encoded. At INTRA frames, the deblocking is activated again, because the residual signal has a much larger energy. Suddenly activating the deblocking filter increases even more the visual gap between INTRA (filtered) and INTER (unfiltered) pictures. The flashing effect is therefore made worse by the deblocking filter adaptive action.

### SUMMARY OF THE INVENTION

It is an object of the invention to propose a technical solution for reducing or cancelling this flashing effect.

To this end, the invention relates to an encoding method such as described in the introductory part of the description and which is moreover characterized in that, before being quantized and encoded in INTRA mode, said INTRA refresh pictures are replaced by an INTER picture having quality and artefacts substantially similar to those of the last encoded INTER picture(s).

This technical solution is efficient in reducing or cancelling the flashing effect, since INTRA refresh frames are not directly encoded for original pictures, as it is generally the case, but from so-called “fake” pictures generated for replacing the refresh pictures. These fake pictures do no exist in the original sequence of pictures but have the same quality and artefacts as other temporally predicted pictures of said sequence. The encoder takes care to encode this different version of the pictures, and the visual quality of the decoded picture then remains equal to that of other pictures said decoded picture does not look like an INTRA picture, as if it had not been refreshed and encoded only in the INTER mode.

It is another object of the invention to propose an encoding device allowing to carry out said encoding method.

To this end, the invention relates to an encoding device provided for encoding digital video data corresponding to an original sequence of images and available in the form of a video stream consisting of successive pictures which are either INTRA pictures, called I-pictures and encoded by means of a so-called INTRA mode without any reference to any past or future picture, or INTER pictures, that are themselves either monodirectionally predicted pictures, called P-pictures and encoded with reference to a past or future reference picture which is an INTRA or INTER picture, or bidirectionally predicted pictures, called B-pictures and encoded with reference to one or more reference picture(s), said INTRA pictures themselves comprising either I-pictures placed at the beginning of a new group of pictures corresponding to a scene change, where no temporal redundancy is available, and called scene change I-pictures, or I-pictures placed in other locations, where some temporal redundancy is available, and called refresh pictures, said encoding device, intended to generate an output coded bitstream, comprising at least a quantizing and coding branch, which receives and encodes the sequence of I, P, B pictures to be encoded, a prediction branch, which reconstructs predicted pictures corresponding to the received pictures that are respectively encoded, and a controlling branch which controls the successive encoding operations applied to said I, P, B pictures, said controlling branch controlling, when the I picture to be encoded is a refresh picture, the implementation of the following steps:

(a) the concerned INTRA refresh picture is encoded as an INTER picture, similarly to the encoding step of the previous INTER picture(s) of the sequence, no corresponding output bits being however sent into the output coded bitstream;

(b) the temporally predicted picture corresponding to the encoded INTRA refresh picture thus obtained is reconstructed;

(c) the reconstructed picture thus obtained is encoded in INTRA mode, the corresponding output bits being now sent into said output coded bitstream.

### BRIEF DESCRIPTION OF THE DRAWINGS

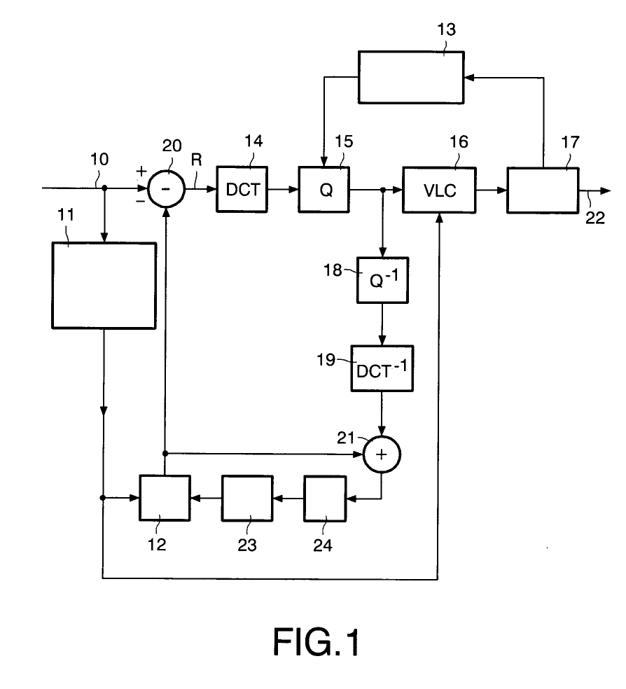

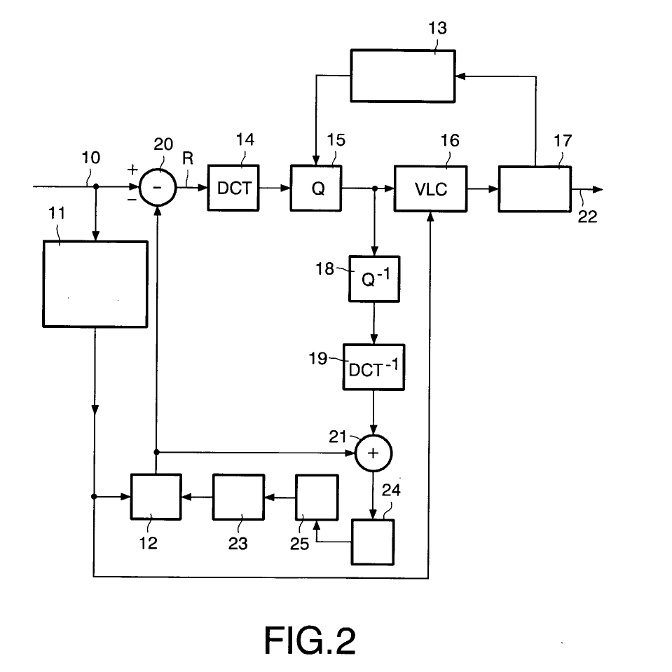

The present invention will now be described, by way of example, with reference to the accompanying drawings, in which FIGS. 1 and 2 illustrate two embodiments of a coding system.

### BRIEF DESCRIPTION OF THE INVENTION

An example of conventional coding system is illustrated in FIG. 1. As illustrated, said system, the input of which receives an input video sequence 10, comprises a motion estimation module 11, a motion compensation module 12, a rate control module 13, a DCT module 14, a quantization (Q) module 15, a variable length coding (VLC) module 16, a buffer 17 (at the output of which a coded bitstream 22 that has to be stored or transmitted to the decoding side is available), an inverse quantization (Q⁻¹) module 18, an inverse DCT (DCT⁻¹) transform module 19, a subtractor 20, an adder 21 and a frame memory 23 (although this system comprises a plurality of modules, those skilled in the art will realize that the functions performed by the various modules are not required to be isolated into separate modules as shown in FIG. 1, and that, for example, the set of modules comprising the motion compensation module 12, the inverse quantization module 18 and the inverse DCT module 19 can be implemented as an “embedded decoder”). A deblocking filter (shown in FIG. 1, with the reference 24) may be provided between the output of the adder 21 and the input of the frame memory 23. In accordance with the MPEG standard and all digital block-based video encoding systems, the input pictures are, as previously said, of I, P or B type.

The first step of the coding method according to the invention will now be described. When an INTRA refresh picture, that should be encoded in INTRA mode, is present at the input 10 of the coding system, said picture is in fact not coded in INTRA mode, but as a P picture, similarly to the last real picture, in order to obtain a fake reconstructed picture having substantially the same quality and artefacts as other temporally predicted pictures (or very similar ones). However, no bits are output to the coded bitstream (at the decoding side, the decoder would expect an INTRA picture).

The following steps of the coding method are then the following one. First, the temporally predicted picture corresponding to the encoded refresh picture thus obtained is reconstructed in the prediction branch comprising the modules 12, 18 and 19. Then the reconstructed picture thus obtained, which now includes temporal defects similar to those of the previous P-pictures, takes the place of the INTRA refresh picture and is encoded in the INTRA mode. This time, the encoded bits thus generated are output to the coded bitstream.

The advantage of the invention may be observed at the decoding side. The decoder does not know that it is decoding a fake picture when it begins decoding a new GOP, but the visual quality of the refresh picture remains equal to other pictures and does not look like an INTRA picture, as if it had not been refreshed.

It can be mentioned that the method and device according to the present invention are not limited to the above-indicated implementation, and that other embodiments may be proposed.

For example, when the fake picture obtained according to the invention is encoded in the INTRA mode, the encoder will reproduce (as planned in accordance with the principle of the invention) the temporal artefacts, but it is preferable not to introduce visible spatial artefacts. It is consequently proposed to use significantly lower quantization levels than for the other INTER pictures. It is thus possible to minimize spatial artefacts.

In the proposed embodiment of the invention, the method described above is applied only to a limited category of INTRA pictures (the INTRA refresh pictures). It can also be applied to all INTRA pictures, but, in this case, if lower quantization levels have been moreover used, it will then be advantageous to disable the method at scene cuts, since the encoding of the fake picture costs more bits (due to the lower quantization levels).

Also in order not to introduce visible spatial artefacts, when the encoder is an H.264 encoder including a deblocking filter in its decoding loop (it is a normative part of H.264, since the encoding and decoding devices then perform the same filtering to avoid drift effects), said deblocking filter is disabled for the INTRA refresh pictures. It is thus possible to avoid filtering the fake picture reconstruction, which already takes into account the action of the deblocking filter on INTER pictures. This disabling operation must be signaled in the coded bitstream.

A disabling operation may also be proposed for refresh pictures in scenes undergoing large motions, in order to save bits. It can be justified by the fact that the flashing effect is not visible in such scenes.

It may also be proposed, as shown in FIG. 2, to add in the prediction branch (with or without the deblocking filter 24), between the output of the adder 21 and the input of the frame memory 23, a temporal filtering circuit 25. Different implementations may be proposed for such a circuit. For example, it could keep in memory (in a memory having the size of an image) the previous (or a previous) image or the following (or a following) image, or keep in memory a lot of past and/or next images and filter corresponding pixels using median filters or filters of a similar nature. With such a structure, the prediction step is more accurate and the residual signal obtained at the output of the subtractor 20 (by difference between the input signal and the predicted one) is smaller, i.e. the compression factor is improved. The image reconstruction at the decoding side is then performed with a higher quality. It can be noted that, the deblocking filter 24 may be present, or not, in the prediction branch.

It can be added here that there are numerous ways of implementing functions by means of items of hardware or software, or both. In this respect, the drawings are very diagrammatic. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description; with reference to the drawings, illustrates rather than limits the invention, and that there are numerous alternatives falling which fall within the scope of the appended claims. The word “comprising” does not exclude the presence of other elements or steps than those listed in a claim. The word “a” or “an” preceding an element or step does not exclude the presence of a plurality of such elements or steps.

1. A method of encoding digital video data corresponding to an original sequence of images and available in the form of a video stream consisting of successive pictures which are either INTRA pictures, called I-pictures and encoded by means of a so-called INTRA mode without any reference to any past or future picture, or INTER pictures, that are themselves either monodirectionally predicted pictures, called P-pictures and encoded with reference to a past or future reference picture which is an INTRA or INTER picture, or bidirectionally predicted pictures, called B-pictures and encoded with reference to one or more reference picture(s), said INTRA pictures themselves comprising either I-pictures placed at the beginning of a new group of pictures corresponding to a scene change, where no temporal redundancy is available, and called scene change I-pictures, or I-pictures placed in other locations, where some temporal redundancy is available, and called refresh pictures, said method, intended to generate an output coded bitstream, being characterized in that, before being quantized and encoded in INTRA mode, said INTRA refresh pictures are replaced by an INTER picture having quality and artefacts substantially similar to those of the last encoded INTER picture(s).

2. An encoding method according to claim 1, in which each INTRA refresh picture is encoded by implementation of the following steps:
(a) the concerned INTRA refresh picture is encoded as an INTER picture, similarly to the encoding step of the previous INTER picture(s) of the sequence, no corresponding output bits being however sent into the output coded bitstream
(b) the temporally predicted picture corresponding to the encoded INTRA refresh picture thus obtained is reconstructed;
(c) the reconstructed picture thus obtained is encoded in INTRA mode, the corresponding output bits being now sent into said output coded bitstream.

3. An encoding method according to claim 1, in which each INTRA refresh picture is encoded by implementation of the following steps
(a) the concerned INTRA refresh picture is encoded as a P-picture, similarly to the encoding step of the previous P-picture of the sequence, no corresponding output bits being however sent into the output coded bitstream
(b) the temporally predicted picture corresponding to the encoded INTRA refresh picture thus obtained is reconstructed;
(c) the reconstructed picture thus obtained is encoded in INTRA mode, the corresponding output bits being now sent into said output coded bitstream.

4. An encoding method according to claim 2, in which, before the final encoding step, the quantizing step of the concerned INTRA refresh pictures is performed with a quantization level significantly lower than for the other INTER pictures.

5. An encoding method according to claim 4, wherein it is applied to all INTRA pictures, except those located just after the scene cuts.

6. An encoding method according to claim 4, wherein it is applied to all INTRA pictures, except to the INTRA refresh pictures located in scenes undergoing large motions.

7. An encoding method according to claim 1, in which, when said sequence is processed by an H.264-like encoder comprising a deblocking filter in its decoding loop, said deblocking filter is disabled for INTRA refresh pictures.

8. An encoding device provided for encoding digital video data corresponding to an original sequence of images and available in the form of a video stream consisting of successive pictures which are either INTRA pictures, called I-pictures and encoded by means of a so-called INTRA mode without any reference to any past or future picture, or INTER pictures, that are themselves either monodirectionally predicted pictures, called P-pictures and encoded with reference to a past or future reference picture which is an INTRA or INTER picture, or bidirectionally predicted pictures, called B-pictures and encoded with reference to one or more reference picture(s), said INTRA pictures themselves comprising either I-pictures placed at the beginning of a new group of pictures corresponding to a scene change, where no temporal redundancy is available, and called scene change I-pictures, or I-pictures placed in other locations, where some temporal redundancy is available, and called refresh pictures, said encoding device, intended to generate an output coded bitstream, comprising at least a quantizing and coding branch, which receives and encodes the sequence of I, P, B pictures to be encoded, a prediction branch, which reconstructs predicted pictures corresponding to the received pictures that are respectively encoded, and a controlling branch which controls the successive encoding operations applied to said I, P, B pictures, said controlling branch controlling, when the I picture to be encoded is a refresh picture, the implementation of the following steps:
(a) the concerned INTRA refresh picture is encoded as an INTER picture, similarly to the encoding step of the previous INTER picture(s) of the sequence, no corresponding output bits being however sent into the output coded bitstream
(b) the temporally predicted picture corresponding to the encoded INTRA refresh picture thus obtained is reconstructed;
(c) the reconstructed picture thus obtained is encoded in INTRA mode, the corresponding output bits being now sent into said output coded bitstream.

9. An encoding device according to claim 8, in which, in the step (a), said INTER picture is a P-picture.

10. An encoding device according to claim 8, in which the concerned INTRA refresh pictures are, before they are encoded in the final encoding step, quantized with a quantization level significantly lower than for the other INTER pictures.

11. An encoding device according to claim 10, wherein it is applied to all INTRA pictures, except those located just after the scene cuts.

12. An encoding device according to claim 10, wherein it is applied to all INTRA pictures, except to the INTRA refresh pictures located in scenes undergoing large motions.

13. An encoding device according to claim 10, in which, when said sequence is processed by an H.264-like encoder comprising a deblocking filter in its decoding loop, said deblocking filter is disabled for INTRA refresh pictures.
